(19) United States
(12) Patent Application Publication
(10) Pub. No.: US 2018/0040280 A1
(43) Pub. Date: Feb. 8, 2018

(54) LASER LIGHT REGULATION SYSTEM

(71) Applicant: Megaforce Company Limited, New Taipei City (TW)

(72) Inventors: Wei-Chih Lin, New Taipei City (TW); Wei-Hsuan Chen, New Taipei City (TW)

(21) Appl. No.: 15/227,794

(22) Filed: Aug. 3, 2016

(51) Int. Cl. G09G 3/34; G02F 1/1335; G09G 3/00; G02B 26/04; H01S 3/00; H05B 37/02; G02F 1/133

(52) U.S. Cl. CPC G09G 3/3406; H05B 37/0218; G02F 1/133528; G02F 1/13306; G02B 26/04; H01S 3/0085; G09G 3/002; G09G 2360/144; G09G 2310/0267

(57) ABSTRACT

A laser light regulation system comprises: an ambient light sensor, used to detect luminance of ambient light; a luminance mode determination circuit, to receive signals from the ambient light sensor; a luminance control module; an MEMS (micro-electromechanical system) scanner; an image processor; a laser driving circuit; a laser light source; and a scanner driving circuit. The luminance mode determination circuit receives signals from the ambient light sensor, and then it outputs a luminance mode signal to the luminance control module. The luminance control module projects images of corresponding luminance, based on luminance of ambient light, so that the viewer may view information in the image clearly and comfortably.

### BACKGROUND OF THE INVENTION

### Field of the Invention

The present invention relates to a light regulation system, and in particular to a laser light regulation system, for which the luminance of images emitted can be adjusted based on the ambient light luminance.

### The Prior Arts

In this respect, as an example of the Prior Art, U.S. Pat. No. 9,167,655 disclosed a Backlight Adjustment System. Refer to FIG. 1 for a perspective view of an exemplary electronic display. As shown in FIG. 1, the system includes an ambient light sensor 170, a back light sensor 171, and a temperature sensor 175. When backlight is emitted from a backlight unit 120, the software driver 190 will send a signal to a current measurement device 200 to measure the current delivered by the power source 195, and send back the information to the software driver 190. In turn, the software driver 190 will send instructions to the power source 195, to regulate the power sent to the current measurement device 200 and the backlight unit 20, in achieving adjustment of light luminance of the backlight unit 120.

In another example of the Prior Art, Taiwan Patent No. 1462648 disclosed a Backlight Driving Circuit and a Backlight Driving Method. Refer to FIG. 3 for a flowchart of the steps of a single loop circuit charging method. As shown in FIG. 3, firstly, in Step S410, a control circuit 105 controls the power source VS to provide voltage to an anode of a light-emitting-diode (LED) 102. Next, in step S420, a light sensitive element 104 senses the luminance of the ambient light, and is disposed between the cathode of the light-emitting-diode 102 and the ground, while its electric resistance can be varied based on the ambient light luminance of the electronic device. And finally, in step S430, the control circuit 105 regulates the output voltage of the power source VS, to control luminance of the light-emitting-diode 102 based on the feedback voltage VFB of the LED 102.

In yet another example of the Prior Art, U.S. Pat. No. 8,848,289 disclosed a Near-To-Eye Display With Diffractive Lens, that includes a waveguide 205, a polarizer 215, a wire grid polarizer 210, and a collimating lens 255. In such a structure, the polarizer 215 is capable of controlling the wire grid polarizer 210 based on the variations of the ambient light, to regulate luminance of the images emitted from the waveguide 205. Then, the images transmitted through the collimating lens 255 may enter into viewer's eyes, for the viewer to view the images clearly.

In a further example of the Prior Art, U.S. Pat. No. 8,436,952 discloses a Hybrid Illumination System For Head-Up Display, comprising one or more optics units 110, a light mixing unit 170, a condensing unit 180, a polarizing beam splitter 190, and a reflective display unit 200. In such a device, the one or more optics units 110 guides the ambient light into the light mixing unit 170, which homogenizes all the lights therein, and outputs the lights to the condensing unit 180, that condenses the lights and then outputs them to a polarizing beam splitter 190. Through the polarizing beam splitter 190 and the reflective display unit 200, the modulated lights are projected onto a windshield to form images, in realizing a Head Up Display (HUD).

In a final example of the Prior Art, U.S. Pat. No. 7,203,005 disclosed a Head Up Display (HUD) system 100, including a polarized image generating system 110, a polarization preserving rear projection screen 120, and a polarizing reflector 130 on a windshield 100. In this HUD system 100, polarizing reflector 130 and projection screen 120 are utilized to raise luminance of the display, so that the display may have low haze and high light transmittance, thus suitable to be used as a windshield of a vehicle.

However, the light emitting devices of the Prior Art mentioned above are not able to avoid effectively the problem that, the images emitted in high ambient light luminance tend to appear blurring, while the images emitted in low ambient light luminance tend to appear dazzling to the viewer.

Therefore, presently, the design of the light emitting device is not quite satisfactory, and it leaves much room for improvement.

### SUMMARY OF THE INVENTION

The objective of the present invention is to provide a laser light regulation system, that is capable of regulating automatically luminance of the images emitted, based on the luminance of ambient light, so that in daytime or nighttime, the images emitted will not appear to be blurring or dazzling to a viewer.

In order to achieve the objective mentioned above, the present invention provides laser light regulation system, including an image processor; an ambient light sensor; a luminance mode determination circuit, connected electrically to the ambient light sensor; a laser driving circuit, connected electrically to the image processor; a laser light source, connected electrically to the laser driving circuit to emit laser lights; a luminance control module, connected electrically to the luminance mode determination circuit; a scanner driving circuit, connected electrically to the image processor; and an MEMS (micro-electromechanical system) scanner, controlled by the scanner driving circuit to perform scanning, and to reflect the laser light coming from the polarizer.

The luminance control module includes a luminance control circuit, a liquid crystal, and a polarizer. Alternatively, it may include a luminance control circuit, a driving motor, and a polarizer. In application, the luminance control module receives a luminance mode signal from the luminance mode determination circuit, to adjust further luminance of the projected images.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from the detailed descriptions.

### BRIEF DESCRIPTION OF THE DRAWINGS

The related drawings in connection with the detailed descriptions of the present invention to be made later are described briefly as follows, in which:

FIG. 1 is a perspective view of an exemplary electronic display according to the Prior Art;

FIG. 2 is a flowchart of the steps of a single loop circuit charging method according to the Prior Art;

FIG. 3 is a block diagram of a laser light regulation system according to first embodiment of the present invention;

FIG. 4 is a block diagram of a laser light regulation system in a high ambient luminance mode according to a first embodiment of the present invention;

FIG. 5 is a block diagram of a laser light regulation system in a low ambient luminance mode according to a first embodiment of the present invention;

FIG. 6 is a block diagram of a laser light regulation system of another configuration according to a first embodiment of the present invention;

FIG. 7 is a block diagram of a laser light regulation system according to a second embodiment of the present invention; and

FIG. 8 is a block diagram of a laser light regulation system of another configuration according to a second embodiment of the present invention.

### DETAILED DESCRIPTION OF THE PREFERRED EMBODIMENT

The purpose, construction, features, functions and advantages of the present invention can be appreciated and understood more thoroughly through the following detailed description with reference to the attached drawings.

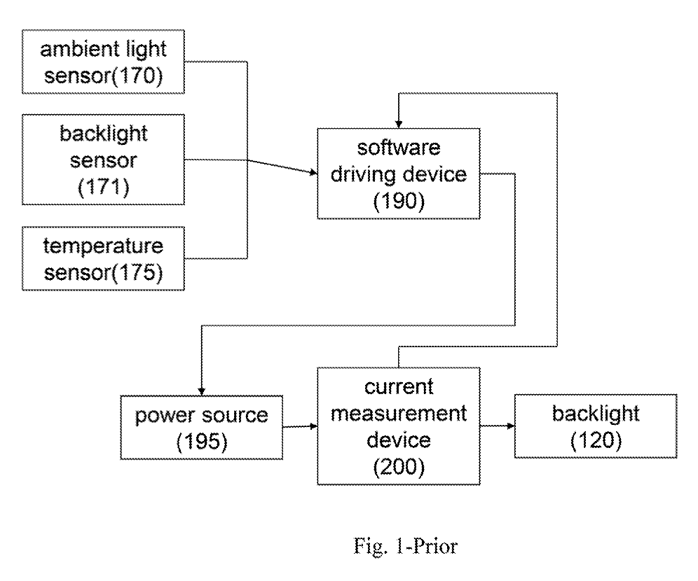

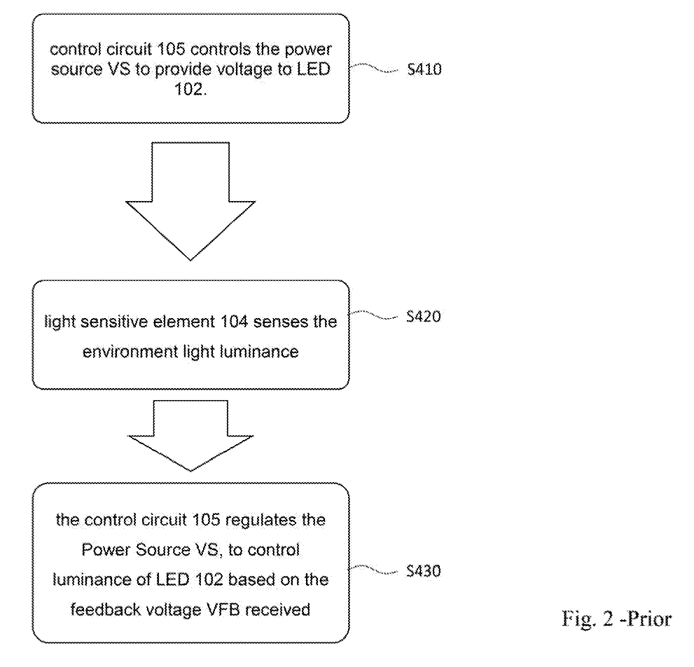

Refer to FIGS. 1 to 8 respectively for a block diagram showing the components for an exemplary embodiment of the control system according to the Prior Art; a flowchart of the steps of a single loop circuit charging method according to the Prior Art; a block diagram of a laser light regulation system according to a first embodiment of the present invention; a block diagram of a laser light regulation system in a high ambient luminance mode according to a first embodiment of the present invention; a block diagram of a laser light regulation system in a low ambient luminance mode according to a first embodiment of the present invention; a block diagram of a laser light regulation system of another configuration according to a first embodiment of the present invention; a block diagram of a laser light regulation system according to a second embodiment of the present invention; and a block diagram of a laser light regulation system of another configuration according to a second embodiment of the present invention.

### Embodiment 1

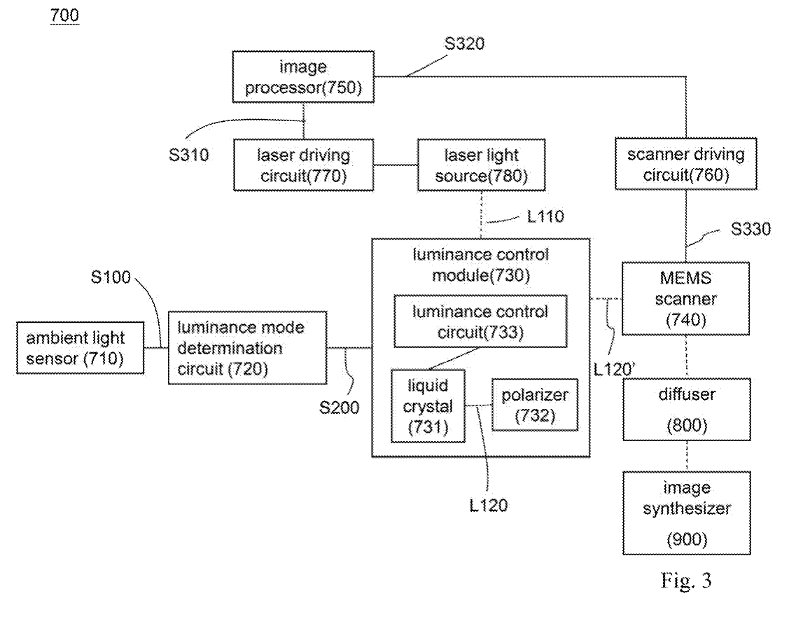

As shown in FIG. 3, the present invention provides a laser light regulation system composed of a display main body 700, which includes: an ambient light sensor 710, a luminance mode determination circuit 720, a luminance control module 730, an MEMS scanner 740, an image processor 750, a scanner driving circuit 760, a laser driving circuit 770, and a laser light source 780. Wherein, the ambient light sensor 710 is used to sense automatically the light luminance of the outside environment, and it outputs a sensed signal S100 to the luminance mode determination circuit 720, which outputs at least a luminance mode signal S200 to a luminance control module 730 based on the sensed signal S100. The luminance control module 730 includes a liquid crystal 731, a polarizer 732, and a luminance control circuit 733. The luminance control module 730 receives the luminance mode signal S200, while the luminance control circuit 733 controls the molecular alignment of the liquid crystal 731.

Further, when the image processor 750 is activated, it will send simultaneously a first driving signal S310 to a laser driving circuit 770, and a second driving signal S320 to a scanner driving circuit 760. Upon receiving the first driving signal S310, the laser driving circuit 770 will output a current to activate a laser light source 780, to make it emit laser light L110 of an image, to the liquid crystal 731 of the luminance control module 730. Since when the liquid crystal 731 receives the luminance mode signal S200, its molecular alignment has been adjusted by the luminance control circuit 733, as such, when the laser light L110 is received, the luminance mode signal S200 will cause the liquid crystal 731 to output different projection luminance signals L120 to a polarizer 732. After the projection luminance signal L120 is adjusted by the polarizer 732, a projection luminance signal L120′ is output.

The scanner driving circuit 760 outputs a third driving signal S330 to an MEMS (micro-electromechanical system) scanner 740, which can be of an MEMS type. Meanwhile, the MEMS scanner 740 receives the projection luminance signal L120′ from the luminance control module 730, and then the MEMS scanner 740 outputs the projection luminance signal L120′ to the diffuser 800, for it to reduce light spots in the projected image, and then it outputs the image to an image synthesizer 900 to display the image. The maximum luminance of the image is controlled and determined by the luminance mode signal. By way of example, since the system may include a high luminance mode signal and a low luminance mode signal, and in the case of low luminance mode signal, the maximum luminance of an image is only half of that as provided by the maximum signal of the system.

### Embodiment 1—High Ambient Luminance Mode

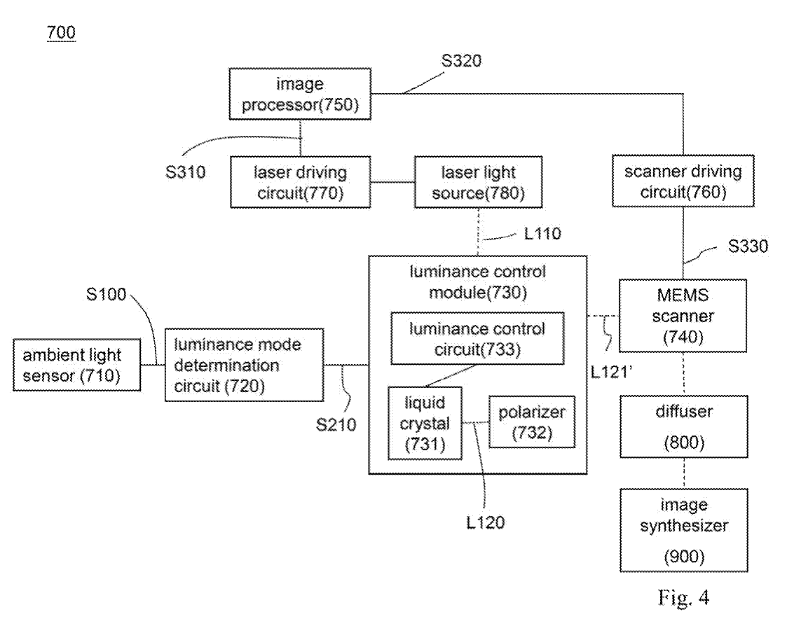

Refer to FIG. 4 for a block diagram of a laser light regulation system in a high ambient luminance mode according to a first embodiment of the present invention. As shown in FIG. 4, when the ambient light luminance is high, the ambient light sensor 710 will detect automatically the luminance of the light source, and outputs a sensed signal S100 to a luminance mode determination circuit 720, which in turn outputs high luminance mode signal S210 to a luminance control module 730. In the luminance control module 730, the luminance control circuit 733 controls the molecular alignment of the liquid crystal 731, and it utilizes the laser light L110 received to output a high projection luminance signal L121 to the MEMS scanner 740, which in turn outputs the high projection luminance signal L121 to a diffuser 800, for it to reduce light spots in the projected image, and then it outputs the image to an image synthesizer 900 to display the image, so that a viewer may view clearly the information contained in the projected image without feeling blurring, even in the condition of high ambient light luminance.

### Embodiment 1—Low Ambient Luminance Mode

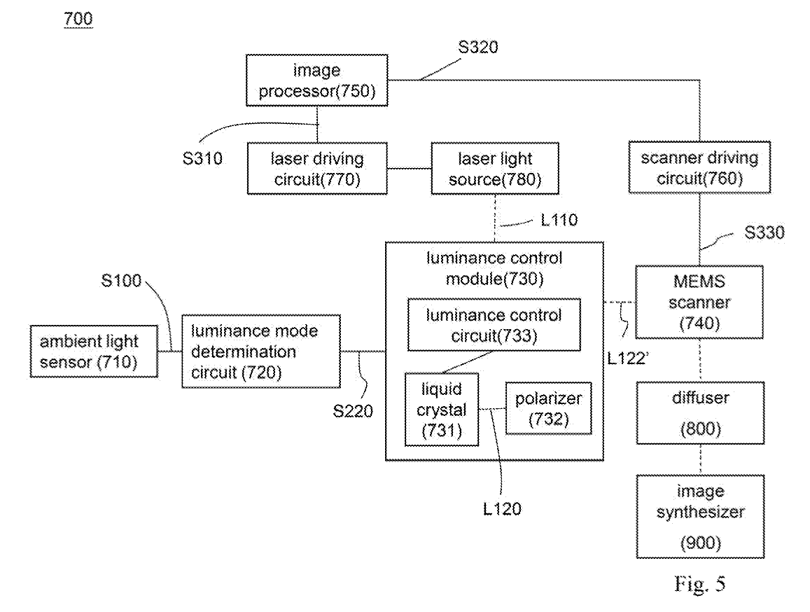

Refer to FIG. 5 for a block diagram of a laser light regulation system in a low ambient luminance mode according to a second embodiment of the present invention. As shown in FIG. 5, when the ambient light luminance is low, the ambient light sensor 710 will detect automatically the luminance of the light source, and outputs a sensed signal S100 to a luminance mode determination circuit 720, which in turn outputs a low luminance mode signal S220 to a luminance control module 730. In the luminance control module 730, the luminance control circuit 733 controls the molecular alignment of the liquid crystal 731, and it utilizes the laser light L110 received to output a low projection luminance signal L122 to the MEMS scanner 740, which in turn outputs the high projection luminance signal L121 to a diffuser 800, for it to reduce light spots of the projected image, and then it outputs the image to the image synthesizer 900 to display the image, so that a viewer may view clearly the information contained in the projected image without feeling dazzled, even in the condition of low ambient light luminance.

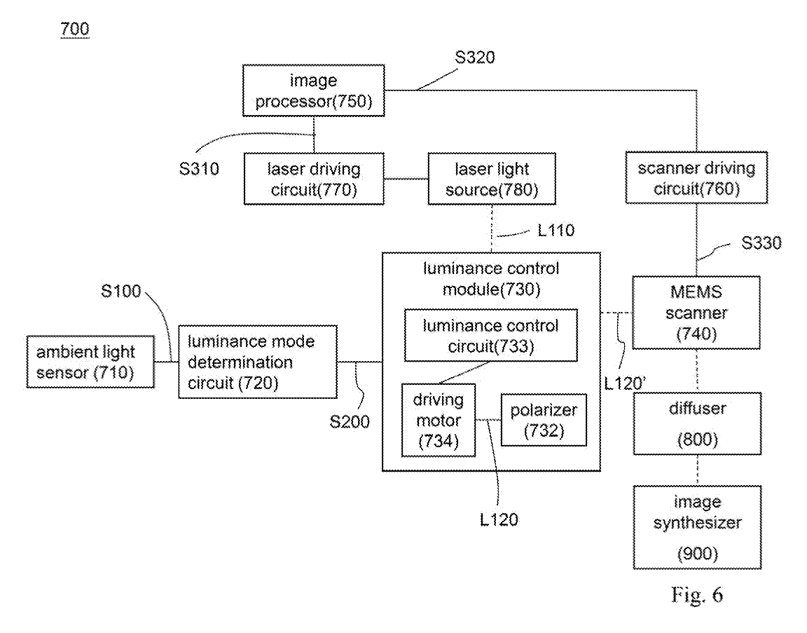

Refer to FIG. 6 for a block diagram of a laser light regulation system of another configuration according to a first embodiment of the present invention. Wherein, the luminance control module 730 can be of another configuration. In application, upon receiving the luminance mode signal S200, the luminance control circuit 733 controls the driving motor 734, to drive the polarizer 732 connected electrically into rotation. As such, the driving motor 734 drives the polarizer 732 into rotating to various angles based on the luminance mode signal S200. When the laser light L110 output by the laser light source 780 reaches the polarizer 732, the driving motor 734 drives the polarizer 732 to rotate to various angles, such that it outputs the projection luminance signal L120′ of various intensities to the MEMS scanner 740.

### Embodiment 2

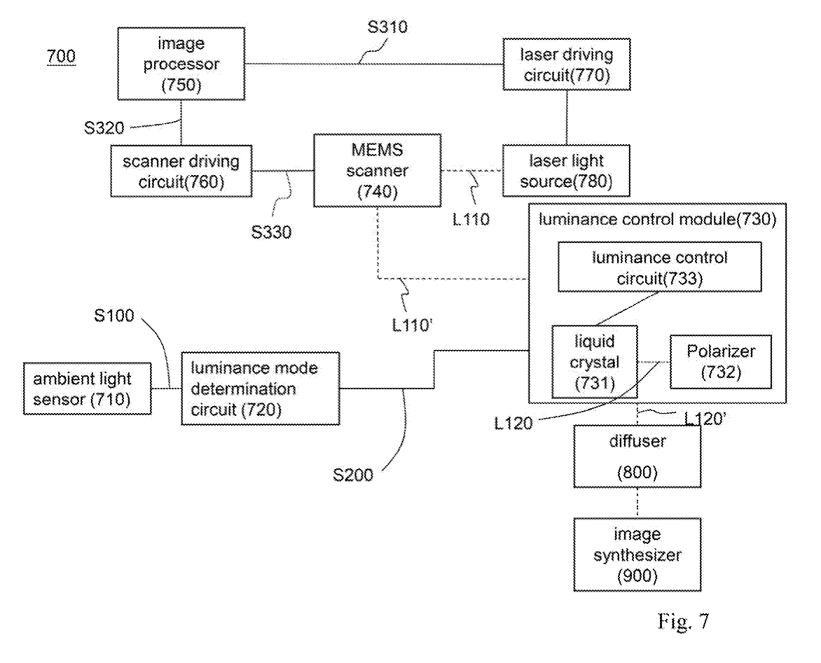

Moreover, refer to FIG. 7 for a block diagram of a laser light regulation system according to a second embodiment of the present invention. As shown in FIG. 7, the MEMS scanner 740 is placed in front of the luminance control module 730, such that when the laser light L110 is projected onto the MEMS scanner 740, it will receive a third driving signal S330 at the same time, and outputs a laser light L110′ to the liquid crystal 731 and polarizer 732 of the luminance control module 730. The luminance mode determination circuit 720 outputs a luminance mode signal S200, and that is used to control the luminance control circuit 733, for it to control the molecular alignment of the liquid crystal 731. As such, when the laser light L110′ is projected onto the liquid crystal 731, through different molecular alignments of the liquid crystal 731, the value of the projection luminance signal L120′ projected out from the luminance control module 730 can be varied. Finally, the luminance control module 730 outputs the projection luminance signal L120′ to a diffuser 800, for it in turn outputs the projection luminance signal L120′ to the image synthesizer 900 to display the image.

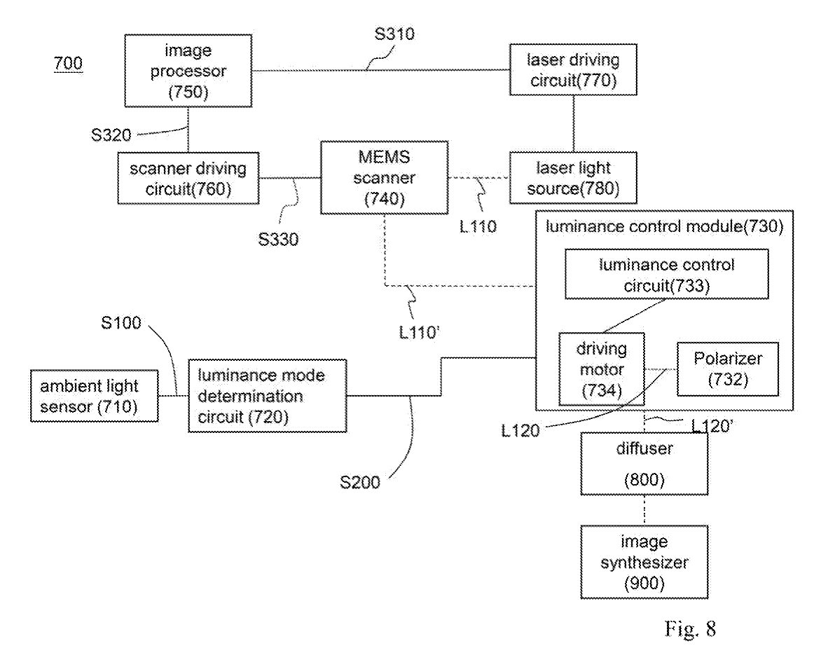

Refer to FIG. 8 for a block diagram of a laser light regulation system of another configuration according to a second embodiment of the present invention. As shown in FIG. 8, the luminance control module 730 can be of another configuration. In application, upon receiving the luminance mode signal S200, the luminance control circuit 733 controls the driving motor 734, to drive the polarizer 732 into rotating to a corresponding angle. Then, the laser light L110′ output from the MEMS scanner 740 is transmitted through the polarizer 732, and then it is output as the projection luminance signal L120′ to the diffuser 800 to reduce the light spot in the projected image. Then, the signal is output and transmitted to the image synthesizer 900 to display the image.

The laser light regulation system of the present invention is suitable to use in a Head Up Display (HUD) of a vehicle, to detect the luminance of ambient light outside the vehicle, and to automatically adjust the images on the Head Up Display (HUD) to a proper luminance in broad day light and at night, without causing blurring or dazzling to the driver, thus improving driving safety.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A laser light regulation system, comprising:
an image processor;
a laser driving circuit, connected electrically to the image processor;
a laser light source, connected electrically to the laser driving circuit to emit laser lights;
an ambient light sensor, used to detect luminance of ambient light;
a luminance mode determination circuit, connected electrically to the ambient light sensor, to send out a luminance mode signal;
a luminance control module, connected electrically to the luminance mode determination circuit, and it includes a liquid crystal, a polarizer, and a luminance control circuit, and the luminance control module controls the liquid crystal based on the luminance mode signal, while the polarizer controls laser light luminance through the liquid crystal;
a scanner driving circuit, connected electrically to the image processor; and
an MEMS (micro-electromechanical system) scanner, controlled by the scanner driving circuit, to reflect the laser light coming from the polarizer, while the maximum light luminance is determined by the luminance mode signal.

2. The laser light regulation system as claimed in claim 1, wherein the liquid crystal molecular alignment is determined by the luminance mode signal.

3. The laser light regulation system as claimed in claim 1, wherein the luminance control module includes a luminance control circuit, a driving motor, and a polarizer, such that the luminance control circuit controls the driving motor to drive the polarizer into rotation based on the luminance mode signal, while the polarizer controls luminance of the laser light.

4. The laser light regulation system as claimed in claim 1, wherein the MEMS scanner is of a micro-electromechanical system (MEMS).

5. The laser light regulation system as claimed in claim 1, wherein the MEMS scanner projects laser lights onto a diffuser, then the diffuser projects laser lights onto an image synthesizer to form an image.

6. A laser light regulation system, comprising:
an image processor;
an ambient light sensor, used to detect luminance of ambient light;
a luminance mode determination circuit, connected electrically to the ambient light sensor, to output at least a luminance mode signal;
a laser driving circuit, connected electrically to the image processor;
a laser light source, connected electrically to the laser driving circuit to emit laser lights;
a scanner driving circuit, connected electrically to the image processor;
an MEMS (micro-electromechanical system) scanner, controlled by the scanner driving circuit to perform scanning, and to reflect the laser light; and
a luminance control module, connected electrically to the luminance mode determination circuit, and it includes a liquid crystal, a polarizer, and a luminance control circuit, and the luminance control circuit controls the liquid crystal based on the luminance mode signal, while the polarizer controls laser light luminance through the liquid crystal, and the maximum light luminance is determined by the luminance mode signal.

7. The laser light regulation system as claimed in claim 6, wherein the liquid crystal molecular alignment is determined by the luminance mode signal.

8. The laser light regulation system as claimed in claim 6, wherein the luminance control module includes a luminance control circuit, a driving motor, and a polarizer, such that the luminance control circuit controls the driving motor to drive the polarizer into rotation based on the luminance mode signal, while the polarizer controls luminance of laser light, and the luminance mode signal determines a maximum luminance of the laser light.

9. The laser light regulation system as claimed in claim 6, wherein the MEMS scanner is of a micro-electromechanical system (MEMS).

10. The laser light regulation system as claimed in claim 6, wherein the MEMS scanner projects the laser light onto a diffuser, then the diffuser projects the laser lights onto an image synthesizer to form an image.
